(19) United States
(12) Patent Application Publication
(10) Pub. No.: US 2026/0022941 A1
(43) Pub. Date: Jan. 22, 2026

(54) SYSTEM AND METHODS FOR DETECTION OF ROUGH ROAD SURFACES AND LANE-KEEP ASSIST SYSTEM BIASING TO AVOID ROUGH ROAD SURFACES

(71) Applicants: Hyundai Motor Company, Seoul (KR); Kia Corporation, Seoul (KR)

(72) Inventors: Brandon Koeth, Superior Township, MI (US); Isaac Mclaws, Superior Township, MI (US)

(21) Appl. No.: 18/776,423

(22) Filed: Jul. 18, 2024

(51) Int. Cl. G01C 21/28; B60W 30/08; B60W 30/12; G01B 21/30

(52) U.S. Cl. CPC G01C 21/28; G01B 21/30; B60W 30/08; B60W 30/12; B60W 2420/403; B60W 2420/408; B60W 2420/54; B60W 2552/35

(57) ABSTRACT

Systems and methods for detecting rough road surfaces and using lane-keep assist system (LKAS) biasing to avoid rough road surfaces are provided. The system may comprise a vehicle, one or more sensors configured to image an environment of a vehicle, and a computing device, comprising a processor and a memory. The memory may be configured to store instructions that, when executed by the processor, are configured to cause the processor to receive input from the one or more sensors, determine one or more vehicle path areas on a road surface using the input from the one or more sensors, evaluate one or more vehicle path areas for one or more rough road surfaces, and bias an LKAS to avoid one or more rough road surfaces. The one or more vehicle path areas may comprise a current vehicle path area and one or more alternative vehicle path areas.

### BACKGROUND

### Technical Field

Embodiments of the present disclosure relate to systems and methods for detecting rough road surfaces and using lane-keep assist system (LKAS) biasing to avoid rough road surfaces.

### Background

Highways develop localized patterns of rough road surfaces/wear caused by road surface damage. This wear is often developed in the center of lanes, where most vehicles travel, Additionally, many North American highways are in poor condition due to heavy truck traffic (e.g., repetitive contact and pressure from semi-trailers), delayed repairs, and other reasons.

Localized patterns of rough surface are often evenly spaced from the center of the lane. Rough surface often correlates with where driver assist features will center the vehicle for either an autonomous or partially autonomous vehicle, Lane-keep assist systems (LKASs) are often configured to center vehicle in lane. However, centering a vehicle in lane places the vehicle over the wear pattern, resulting in poor ride quality.

When vehicles travel over localized road surface damage, cabin noise, ride comfort, and ride safety are negatively affected, particularly when using an LKAS. As a result, vehicle operators often either turn off the LKAS or experience poor ride quality, which negates the benefits of such lane centering systems. As future vehicles use lane centering systems, localized road damage will increase as more traffic is centered.

For at least these reasons, systems and methods for maintaining vehicles within lanes while avoiding rough road surfaces is needed.

### SUMMARY

According to an object of the present disclosure, a system for detecting rough road surfaces and using lane-keep assist system (LKAS) biasing to avoid rough road surfaces is provided. The system may comprise a vehicle, one or more sensors coupled to the vehicle and configured to image an environment of a vehicle, and a computing device, comprising a processor and a memory. The memory may be configured to store instructions that, when executed by the processor, are configured to cause the processor to receive input from the one or more sensors and determine one or more vehicle path areas on a road surface using the input from the one or more sensors. The one or more vehicle path areas may comprise a current vehicle path area and one or more alternative vehicle path areas. The instructions, when executed by the processor, may be further configured to cause the processor to evaluate the one or more vehicle path areas for one or more rough road surfaces and bias an LKAS to avoid one or more rough road surfaces.

According to an exemplary embodiment, the biasing the LKAS may comprise changing a current LKAS bias offset to a new LKAS bias offset that follows an alternative vehicle path area, of the one or more vehicle path areas.

According to an exemplary embodiment, the instructions, when executed by the processor, may be further configured to verify that the new LKAS bias offset provides improved ride quality of the vehicle.

According to an exemplary embodiment, the verifying that the new LKAS bias offset provides improved ride quality of the vehicle may comprise comparing noise and vibration values for the new LKAS bias offset against noise and vibration values of a previous LKAS bias offset.

According to an exemplary embodiment, the verifying that the new LKAS bias offset provides improved ride quality of the vehicle may comprise, when the noise and vibration values for the new LKAS bias offset are not improved over the noise and vibration values of the previous LKAS bias offset, biasing the LKAS to revert back to the previous LKAS bias offset.

According to an exemplary embodiment, the evaluating the one or more vehicle path areas for the one or more rough road surfaces may comprise dividing each vehicle path area, of the one or more vehicle path areas, into a coordinate grid comprising a plurality of grid locations, and evaluating each grid location, of the plurality of grid locations, for roughness.

According to an exemplary embodiment, the biasing the LKAS to avoid the one or more rough road surfaces may comprise determining whether roughness has been detected.

According to an exemplary embodiment, the biasing the LKAS to avoid the one or more rough road surfaces may comprise, when roughness has been detected, grading the roughness and calculating a total path roughness score for each vehicle path area, of the one or more vehicle path areas.

According to an exemplary embodiment, the biasing the LKAS to avoid the one or more rough road surfaces may comprise determining whether a total path roughness score for an alternative vehicle path area is less than a total path roughness score for the current vehicle path area, and, when the total path roughness score for the alternative vehicle path area is less than the total path roughness score for the current vehicle path area, changing an LKAS bias offset to following the alternative vehicle path area.

According to an exemplary embodiment, the one or more sensors may comprise one or more of the following: one or more cameras; one or more LiDAR sensors; one or more radar sensors; one or more noise sensors; and one or more vibration sensors.

According to an object of the present disclosure, a method for detecting rough road surfaces and using LKAS biasing to avoid rough road surfaces is provided. The method may comprise imaging an environment of a vehicle, using one or more sensors coupled to the vehicle and receiving input from the one or more sensors, using a computing device. The computing device may comprise a processor and a memory. The method may comprise, using the computing device, determining one or more vehicle path areas on a road surface using the input from the one or more sensors. The one or more vehicle path areas may comprise a current vehicle path area and one or more alternative vehicle path areas. The method may comprise, using the computing device, evaluating the one or more vehicle path areas for one or more rough road surfaces, and biasing an LKAS to avoid one or more rough road surfaces.

According to an exemplary embodiment, the biasing the LKAS may comprise changing a current LKAS bias offset to a new LKAS bias offset that follows an alternative vehicle path area, of the one or more vehicle path areas.

According to an exemplary embodiment, the method may further comprise verifying that the new LKAS bias offset provides improved ride quality of the vehicle.

According to an exemplary embodiment, the verifying that the new LKAS bias offset provides improved ride quality of the vehicle may comprise comparing noise and vibration values for the new LKAS bias offset against noise and vibration values of a previous LKAS bias offset.

According to an exemplary embodiment, the verifying that the new LKAS bias offset provides improved ride quality of the vehicle may comprise, when the noise and vibration values for the new LKAS bias offset are not improved over the noise and vibration values of the previous LKAS bias offset, biasing the LKAS to revert back to the previous LKAS bias offset.

According to an exemplary embodiment, the evaluating the one or more vehicle path areas for the one or more rough road surfaces may comprise dividing each vehicle path area, of the one or more vehicle path areas, into a coordinate grid comprising a plurality of grid locations, and evaluating each grid location, of the plurality of grid locations, for roughness.

According to an exemplary embodiment, the biasing the LUKAS to avoid the one or more rough road surfaces may comprise determining whether roughness has been detected.

According to an exemplary embodiment, the biasing the LKAS to avoid the one or more rough road surfaces may comprise, when roughness has been detected, grading the roughness and calculating a total path roughness score for each vehicle path area, of the one or more vehicle path areas.

According to an exemplary embodiment, the biasing the LKAS to avoid the one or more rough road surfaces may comprise determining whether a total path roughness score for an alternative vehicle path area is less than a total path roughness score for the current vehicle path area, and, when the total path roughness score for the alternative vehicle path area is less than the total path roughness score for the current vehicle path area, changing an LKAS bias offset to following the alternative vehicle path area.

According to an exemplary embodiment, the one or more sensors may comprise one or more of the following: one or more cameras; one or more LiDAR sensors; one or more radar sensors; one or more noise sensors; and one or more vibration sensors.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below, Unless specifically noted, the drawings referred to in this Brief Description of Drawings should be understood as not being drawn to scale and like reference numerals refer to like parts throughout the various figures unless otherwise specified.

FIG. 1 illustrates a vehicle configured for detecting rough road surfaces and using lane-keep assist system (LKAS) biasing to avoid rough road surfaces, according to an exemplary embodiment of the present disclosure.

FIGS. 2A-2D illustrate a flowchart of a method for detecting rough road surfaces and using LKAS biasing to avoid rough road surfaces, according to an exemplary embodiment of the present disclosure.

FIG. 3 illustrates vehicle path areas according to a first example, according to an exemplary embodiment of the present disclosure.

FIG. 4 illustrates vehicle path areas according to a second example, according to an exemplary embodiment of the present disclosure.

FIG. 5 illustrates vehicle path areas according to a third example, according to an exemplary embodiment of the present disclosure.

FIG. 6 illustrates a coordinate grid superimposed over a vehicle path area, according to an exemplary embodiment of the present disclosure.

FIG. 7 illustrates vehicle path areas, according to an exemplary embodiment of the present disclosure.

FIG. 8 illustrates a left bias path, a center bias path, and a right bias path, according to an exemplary embodiment of the present disclosure.

FIG. 9 illustrates an example architecture of a vehicle, according to an exemplary embodiment of the present disclosure.

FIG. 10 illustrates example elements of a computing device, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing.” “monitoring,” “calibrating.” “estimating,” “initiating.” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein. The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit” “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean, “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices, Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein nay be embodied in the form of one or more of a “chip,” a “package,” an Integrated Circuit (IC).

According to exemplary embodiments, systems and methods for detecting rough road surfaces and using lane-keep assist system (LKAS) biasing to avoid rough road surfaces are provided. According to an exemplary embodiment, vehicle sensors may be used to bias the vehicle within a lane to one side or another to find the best portions of the road surface.

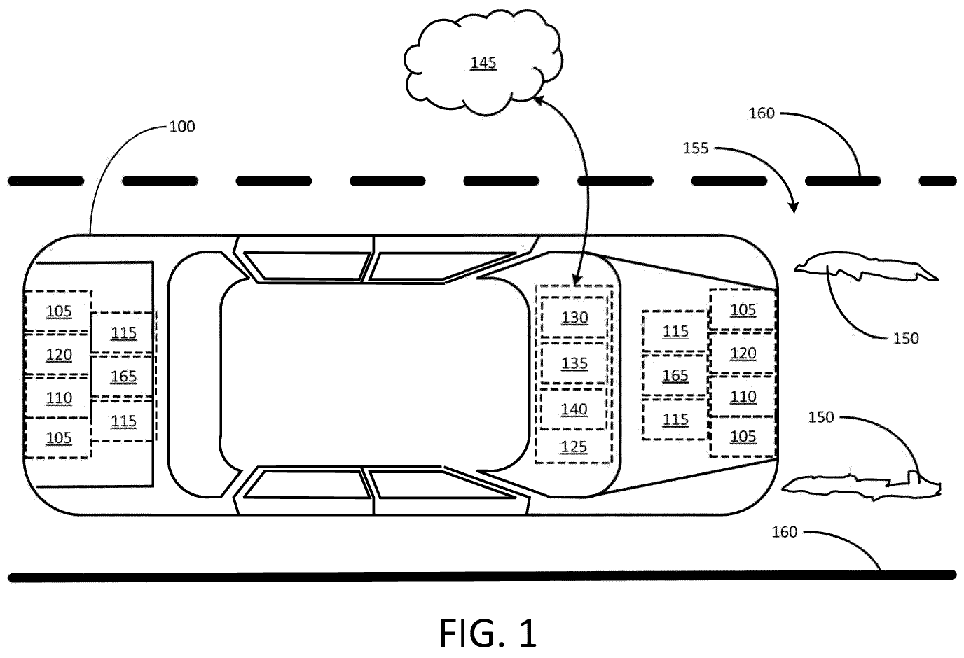

Referring now to FIG. 1, a vehicle 100 configured for detecting rough road surfaces and using LKAS biasing to avoid rough road surfaces is illustratively depicted, in accordance with an exemplary embodiment of the present disclosure. According to an exemplary embodiment, the vehicle 100 may comprise an electric vehicle and/or other suitable vehicle.

According to an exemplary embodiment, the vehicle 100 may comprise one or more sensors such as, for example, one or more LiDAR sensors 105, one or more radio detection and ranging (RADAR) sensors 110, one or more cameras 115, one or more position determining sensors 120 (e.g., one or more Global Positioning System devices and/or other suitable navigation sensors), one or more noise and/or vibration sensors 165, among other suitable sensors, According to an exemplary embodiment, the one or more sensors may be in electronic communication with one or more computing devices 125, The one or more computing devices 125 may be separate from the one or more sensors and/or may be incorporated into and/or coupled to the one or more sensors. According to an exemplary embodiment, the one or more sensors may comprise one or more imaging sensors (e.g., the one or more LiDAR sensors 105, the one or more cameras 115, the one or more radar sensors 110, and/or other suitable imaging sensors) configured to function as an Advanced Driver Assistance System (ADAS). According to an exemplary embodiment, the ADAS may be configured to image an environment of the vehicle 100 (e.g., an environment in which the vehicle 100 is located), generating environmental data. According to an exemplary embodiment, imaging the environment may comprise detecting one or more localized patterns of rough surfaces 150 along a lane 155 of a road, detecting a location of one or more lane edges 160 to ensure that the vehicle 100 is within the lane 155, and/or other suitable functions.

According to an exemplary embodiment, the computing device 125 may comprise a processor 130, a memory 135, and/or a user interface 140 (e.g., a graphical user interface). The computing device 125 may be configured to send and/or receive commands/data/etc. via one or more external systems via wired and/or wireless connection (e.g., via the cloud 145). The memory 135 may be configured to store programming instructions that, when executed by the processor 130, may be configured to cause the processor 130 to perform one or more tasks such as, e.g., receiving one or more inputs from one or more sensors (e.g., one or more LiDAR sensors 105, one or more cameras 115, one or more radar sensors 110, one or more position determining sensors 120, and/or other suitable sensors), determining one or more vehicle 100 path areas (e.g., both a current vehicle path and/or alternate vehicle paths) on a road surface, evaluating one or more vehicle 100 path areas for rough road surfaces 150 (e.g., road damage, cracks, potholes, and/or other suitable rough road conditions), biasing LKAS to avoid the rough road surfaces 150, verifying a new LKAS bias to provide improved ride quality, and/or performing one or more other suitable tasks.

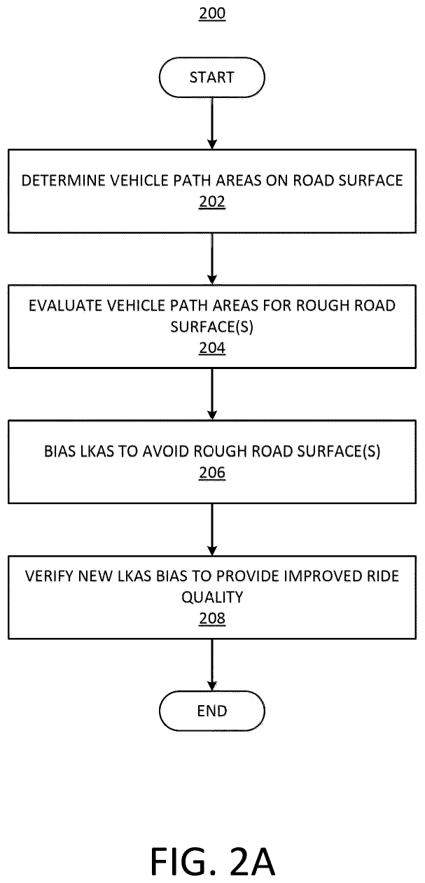

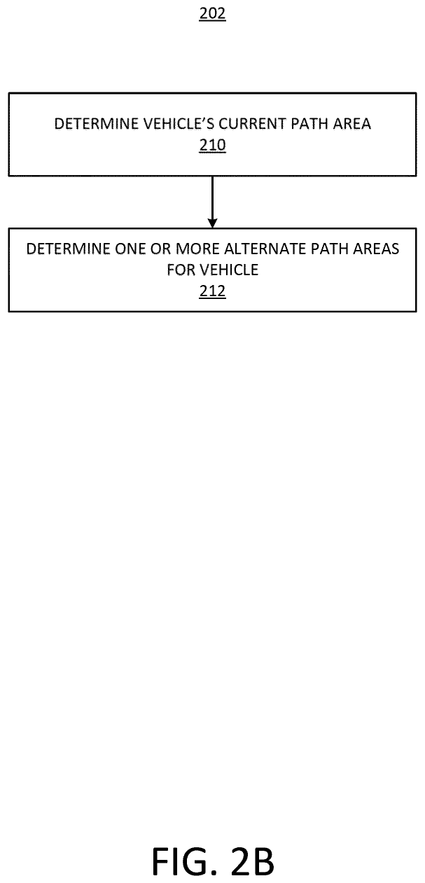

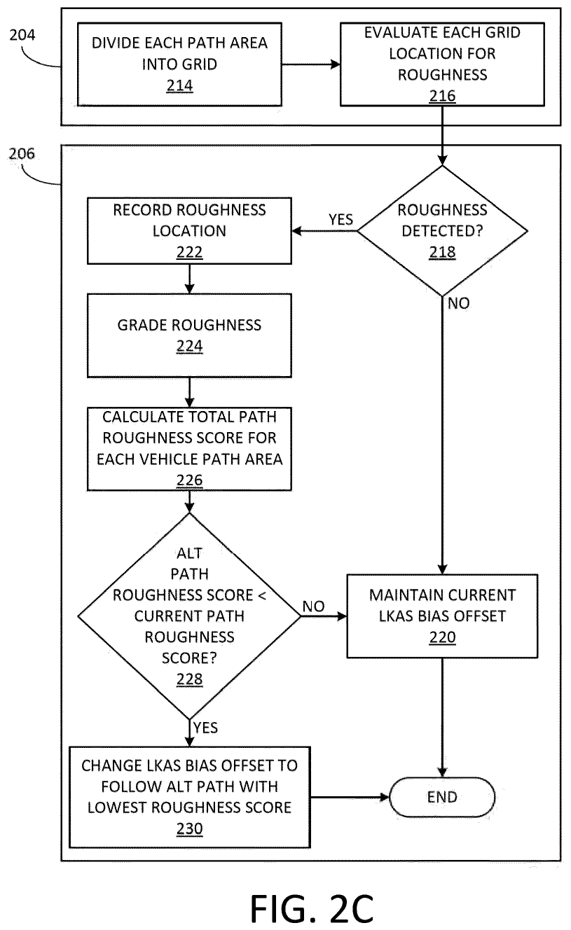

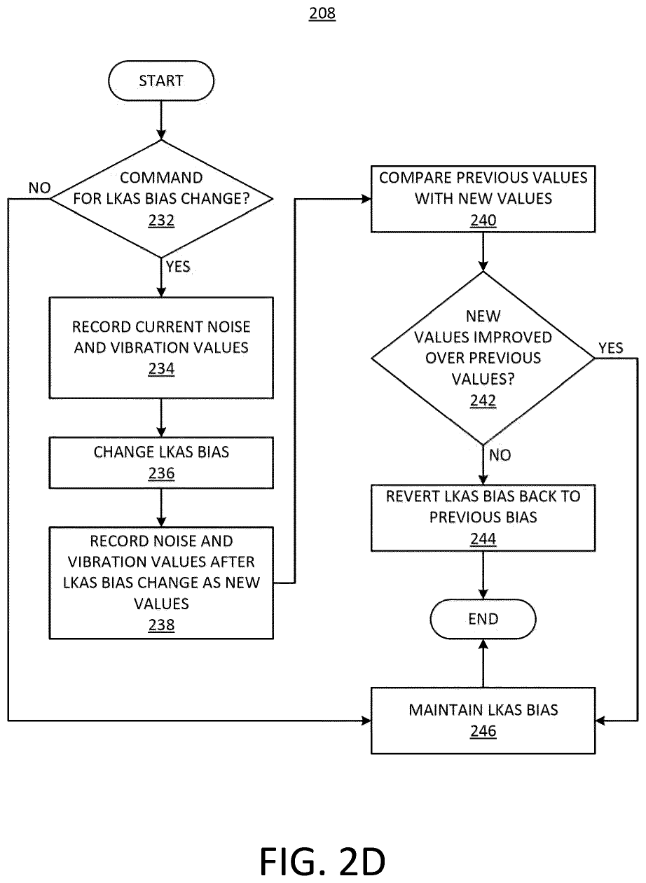

Referring now to FIGS. 2A-2D, flowchart of a method 200 for detecting rough road surfaces and using LKAS biasing to avoid rough road surfaces is illustratively depicted, in accordance with an exemplary embodiment of the present disclosure.

At 202, one or more vehicle path areas on a road surface may be determined (shown, in more detail, in FIG. 2B)

According to an exemplary embodiment, a vehicle path area has one or more vehicle path area dimensions. The one or more vehicle path area dimensions may comprise a lateral dimension (e.g., a tire width) and/or a longitudinal direction. The longitudinal direction may be a function of vehicle speed. The longitudinal direction may increase as vehicle speed increases.

At 210, a vehicle's current path area may be determined. A current vehicle path area may be defined using the tire width, track width, total vehicle width, and/or other suitable measurement, and a current LKAS biasing.

At 212, one or more alternate path areas for a vehicle may be determined.

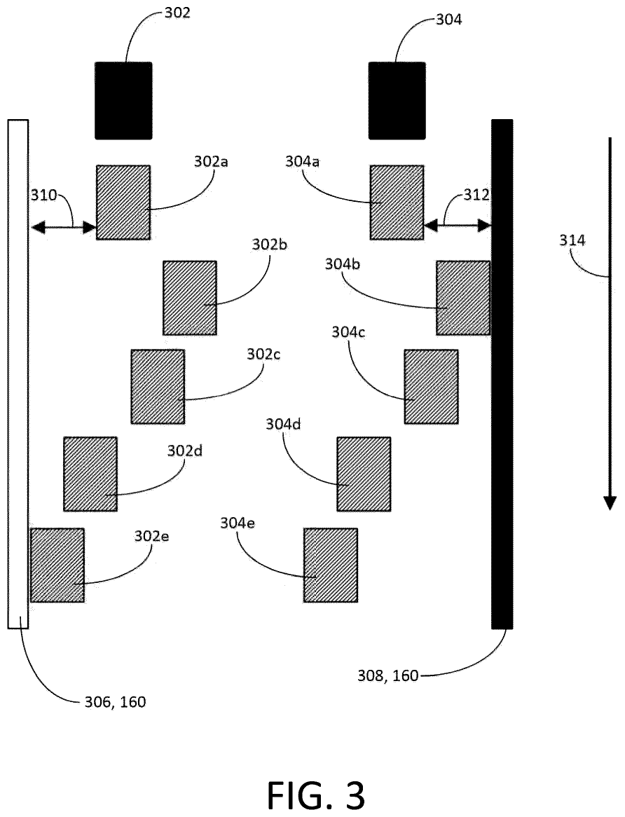

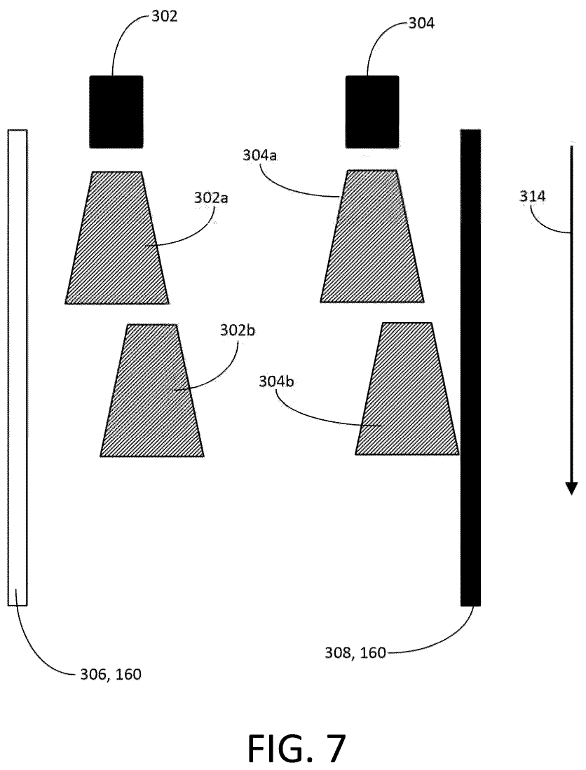

According to an exemplary embodiment, in a first example, an alternate vehicle path area may be determined having equal left 312 and right 310 offsets, as shown, e.g., in FIG. 3, showing positions of the right 302 and left 304 tires of a vehicle traveling in direction 314 between a right lane marker 306 and a left lane marker 308. In this first example, the vehicle path area is defined to the left and right of the vehicle in the lateral direction. As shown in FIG. 3, the positions of the right 302 and left 304 tires in the current vehicle path area are illustrated by vehicle path area 302a (having right offset 310) for the right tire 302 and vehicle path area 304a (having left offset 312) for the left tire 304. While the vehicle path areas are illustrated as rectangular in FIGS. 3-5, it is noted that vehicle path areas may be one or more other suitable shapes, while maintaining the spirit and functionality of the present disclosure. For example, as shown in FIG. 7, the vehicle path areas may be trapezoidal.

In a first alternative path are for the first example, there may be a 100% left lateral offset shift from the current path, illustrated by vehicle path areas 302b and 304b.

In a second alternative path area for the first example, there may be a 50% left lateral offset shift from the current path, illustrated by vehicle path areas 302c and 304c.

In a third alternative path area for the first example, there may be a 50% right lateral offset shift from the current path, illustrated by vehicle path areas 302d and 304d.

In a fourth alternative path area for the first example, there may be a 100% right lateral offset shift from the current path, illustrated by vehicle path areas 302e and 304e.

According to an exemplary embodiment, the number of alternative vehicle path areas may be a function of lane width. For example, a narrow lane may only allow 100% left lateral offset and 100% right lateral offset, and an extra wide lane may allow for 25% left offset, 50% left offset, 75% left offset, 100% left offset, 25% right offset, 50% right offset, 75% right offset, and 100% right offset.

According to an exemplary embodiment, the path area lateral dimension, path area longitudinal dimension, left offset percentages, and/or right offset percentages may be tunable to a specific vehicle application.

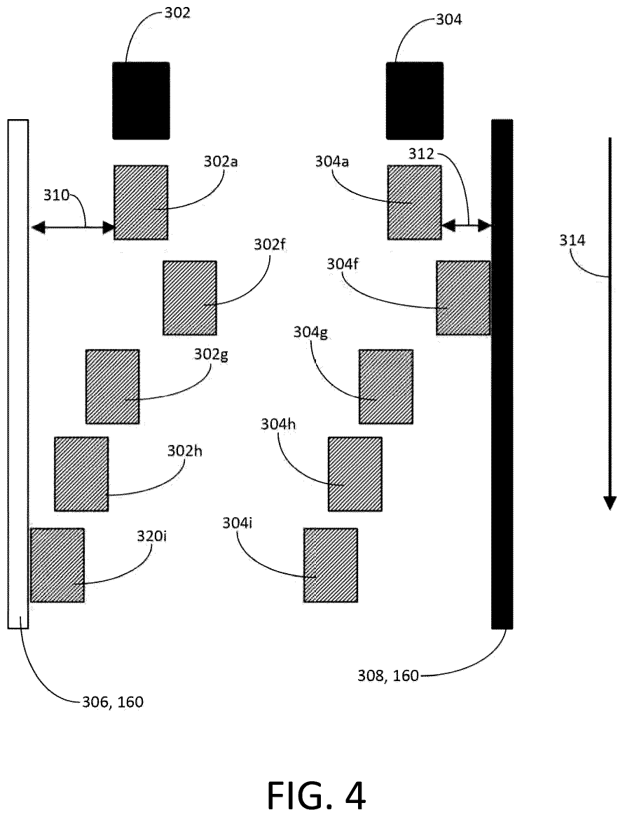

According to an exemplary embodiment, in a second example, an alternate vehicle path area may be determined with vehicle path geometry with LKAS currently biased leftward in lane, as shown, e.g., in FIG. 4, showing positions of the right 302 and left 304 tires of a vehicle traveling in direction 314 between a right lane marker 306 and a left lane marker 308. As shown in FIG. 4, the positions of the right 302 and left 304 tires in the current vehicle path area are illustrated by vehicle path area 302a (having right offset 310) for the right tire 302 and vehicle path area 304a (having left offset 312) for the left tire 304.

In a first alternative path are for the second example, there may be a 100% left lateral offset shift from the current path, illustrated by vehicle path areas 302f and 304f.

In a second alternative path area for the second example, there may be a 33% right lateral offset shift from the current path, illustrated by vehicle path areas 302g and 304g.

In a third alternative path area for the second example, there may be a 67% right lateral offset shift from the current path, illustrated by vehicle path areas 302h and 304h.

In a fourth alternative path area for the first example, there may be a 100% right lateral offset shift from the current path, illustrated by vehicle path areas 302i and 304i.

According to an exemplary embodiment, a current leftward LKAS bias may result in more alternate paths defined to the right of the vehicle. Similarly, rightward LKAS bias may result in more alternate paths defined to the left of the vehicle.

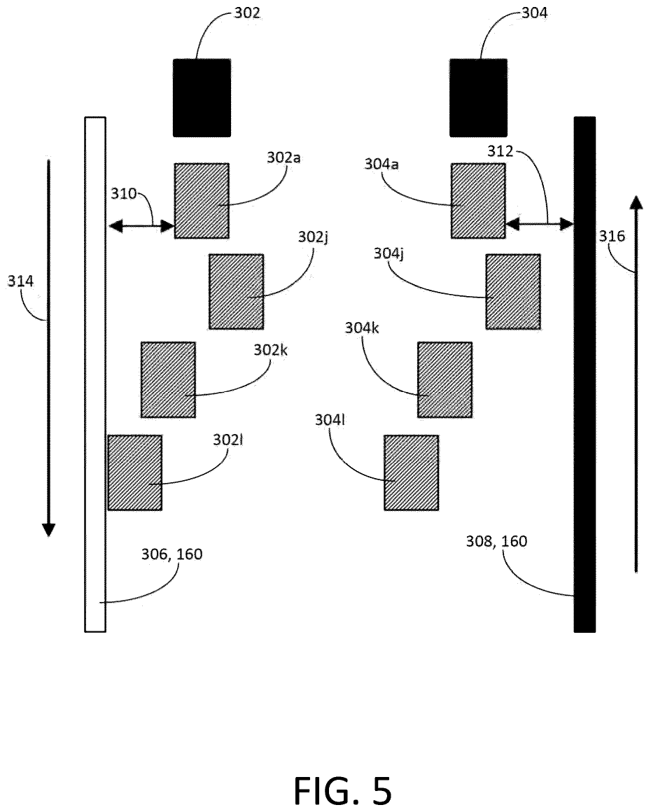

According to an exemplary embodiment, in a third example, an alternate vehicle path area may be determined within a safety margin from an opposing lane, as shown, e.g., in FIG. 5, showing positions of the right 302 and left 304 tires of a vehicle traveling in direction 314 (and opposing traffic traveling in direction 316) between a right lane marker 306 and a left lane marker 308. As shown in FIG. 5, the positions of the right 302 and left 304 tires in the current vehicle path area are illustrated by vehicle path area 302a (having right offset 310 for the right tire 302 and vehicle path area 304a (having left offset 312) for the left tire 304.

In a first alternative path are for the third example, there may be a 50% left lateral offset shift from the current path, illustrated by right tire 302j and left tire 304j.

In a second alternative path area for the third example, there may be a 50% right lateral offset shift from the current path, illustrated by vehicle path areas 302k and 304k.

In a third alternative path area for the third example, there may be a 100% right lateral offset shift from the current path, illustrated by vehicle path areas 302l and 304l.

According to an exemplary embodiment, a 100% left lateral offset shift from the current path may be deleted to provide a safety margin to opposing traffic across a center lane marking.

At 204, one or more vehicle path areas may be evaluated for one or more rough road surfaces (e.g., road damage, cracks, potholes, and/or other suitable rough road conditions) (shown in more detail in FIG. 2C).

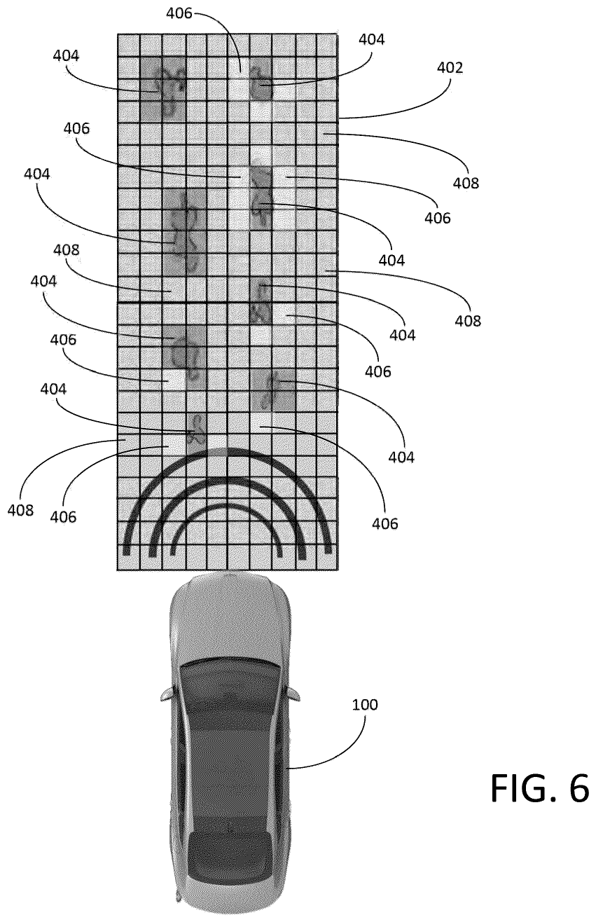

At 214, each vehicle path area (including, e.g., the current vehicle path area and all alternative path areas) may be divided into coordinate grids 402, as shown, e.g., in FIG. 6. At 216, the current vehicle path area and all alternative vehicle path areas may be evaluated for one or more rough road surfaces. According to an exemplary embodiment, the resolution of the coordinate grid 402 within the vehicle path area may be a function of available computing resources. According to an exemplary embodiment, each coordinate grid location within vehicle path area may be checked for indicators of rough road surface. According to an exemplary embodiment, one or more sensors (e.g., one or more LiDAR sensors, one or more cameras, and/or other suitable sensors) may be used to evaluate the road surface roughness at each coordinate grid location.

At 206, the LKAS may be biased to avoid the one or more rough road surfaces (shown in more detail in FIG. 2C).

At 218, it may be determined whether roughness (i.e., one or more rough road surfaces) has been detected. According to an exemplary embodiment, roughness may be detected when the presence of cracks has been detected and the width of the cracks indicates roughness, when the presence of potholes has been detected and the depth of the potholes indicates roughness, and/or when one or more other roughness indicators have been identified/met.

According to an exemplary embodiment, when no roughness has been detected, then, at 220, the current LKAS bias offset may be maintained. According to an exemplary embodiment, when roughness has been detected, then, at 222, each location of roughness/damage may be recorded in the coordinate grid 402, as shown, e.g., in FIG. 6.

According to an exemplary embodiment, at 224, each occurrence of roughness/damage may be graded. As shown, e.g., in FIG. 6, areas of the grid 402 may be graded as having no roughness (areas 408), having minor roughness (areas 406), and/or having severe roughness (areas 404). According to an exemplary embodiment, as a crack's width increases, its roughness score may increase. According to an exemplary embodiment, as a hole depth increases, its roughness score may increase. According to an exemplary embodiment, a roughness grade may be recorded for each coordinate grid location.

According to an exemplary embodiment, at 226, a total path roughness score may be calculated for each vehicle path area (e.g., the current vehicle path area and/or one or more alternative vehicle path areas). The total path roughness score may be calculated using data collected and/or generated comprising one or more optical sensors, one or more ultrasonic sensors, one or more LiDAR sensors, and/or other suitable sensors. According to an exemplary embodiment, the total path roughness score may be calculated using acceleration, sound, strain, and/or other suitable values. According to an exemplary embodiment, a strain measurement may be used as a feedback to validate a former prediction as well as inform one or more future predictions.

More frequent roughness occurrences may indicate a higher pattern of roughness. According to an exemplary embodiment, vehicle path areas having frequent occurrences of minor roughness may have a low path roughness score. According to an exemplary embodiment, vehicle path areas having frequent, occurrences of severe roughness may have the highest path roughness score. According to an exemplary embodiment, vehicle path areas having infrequent occurrences of minor roughness may have a low path roughness score. According to an exemplary embodiment, vehicle path areas having infrequent occurrences of severe roughness may have a high path roughness score. According to an exemplary embodiment, vehicle path areas having no roughness may have the lowest path roughness score.

According to an exemplary embodiment, all road surfaces within a vehicle path area may be analyzed together to calculate the total path roughness score. According to an exemplary embodiment, multiple occurrences of road roughness may be detected and analyzed together to bias LKAS for improved ride quality (e.g., decreases in vibrations, noise and/or other factors and/or increases in even durability effects). This avoids detecting occurrences of road roughness individually with individual responses that are not coordinated and which results in poor ride quality (e.g., jerky movement, swerving responses, etc.)

According to an exemplary embodiment, the total path roughness score may consider vehicle path areas for both left and right tires, According to an exemplary embodiment, the LKAS may be optimized for the lowest path roughness score considering both left and right tires. For example, a single occurrence of severe roughness for the right tire may outweigh no occurrences of roughness for the left tire.

At 228, it may be determined whether any alternative path area's roughness score is less than the roughness score for the current path. When no alternative path area's roughness score is less than the current path area's roughness score, then, at 220, the current LKAS bias offset may be maintained. When any alternative path area's total path roughness score is less than the current path area total path roughness score, then, at 230, the LKAS bias offset may be changed to follow the alternative path with the lowest roughness score.

According to an exemplary embodiment, when any alternative path area's total path roughness score is less than the current path area's total path roughness score, then the vehicle/system may be configured to check for sufficient clearance between the alternative path and the adjoining lane and determine whether there is sufficient clearance between the alternative path and the adjoining lane. When sufficient clearance is not present, the current LKAS bias offset may be maintained. When sufficient clearance is present, the LKAS bias offset may be changed to follow the alternative path. Sufficient clearance may be a threshold distance (e.g., 25 cm and/or other suitable distance). According to an exemplary embodiment, sufficient clearance may be a tunable variable based on vehicle dynamics.

According to an exemplary embodiment, when any alternative path area's total path roughness score is less than the current path area total path roughness score, then the vehicle/system may be configured to notify/prompt a driver to confirm a LKAS bias change. When the driver does not confirm the bias change, then the current LKAS bias offset may be maintained. When the driver does confirm the bias change, then the LKAS bias offset may be changed to follow the alternative path.

At 208, a new LKAS bias may be verified to provide improved ride quality (shown in more detail in FIG. 2D).

At 232, it may be determined whether there have been implemented a command for LKAS bias change. According to an exemplary embodiment, vehicle onboard sensors may be configured to verify that the new path is ride improvement to old path.

When there has not been implemented a command for LKAS bias change, then, at 246, the current LKAS bias may be maintained. When there has been implemented a command for LKAS bias change the, at 234, current noise and vibration values may be recorded. It is noted, however, that other values may be recorded such as, e.g., suspension stroke values, suspension component strain values, and/or other suitable values. The noise levels for vehicle path areas may be quantified using onboard noise and/or vibration sensors. According to data from the noise sensor, a new vehicle path area should be less noisy. According to the vibration sensor, a new vehicle path area should be smoother. According to an exemplary embodiment, one or more other suitable sensors may be used, while maintaining the spirit and functionality of the present disclosure.

According to an exemplary embodiment, noise and vibration values recorded prior to an LKAS bias change may be labeled as previous values. According to an exemplary embodiment, noise and vibration values recorded after an LKAS bias change may be labeled as new values. At 240, the previous values may be compared against the new values. At 242, it may be determined whether the new values improved over the previous values. Noise is improved if noise decreases, and vibration is improved if vibration decreases.

When the new values improved over the previous values, then, at 246, the current LKAS bias may be maintained. When the new values do not improve over the previous values, then, at 244, the LKAS bias may revert to an old bias and, at 202, one or more vehicle path areas on a road surface may be determined. Noise is not improved if noise increases, and vibration is not improved if vibration increases. Preferably, for overall improvement, both noise and vibration must improve. Alternatively, noise and vibration values may be weighted to determine overall improvement.

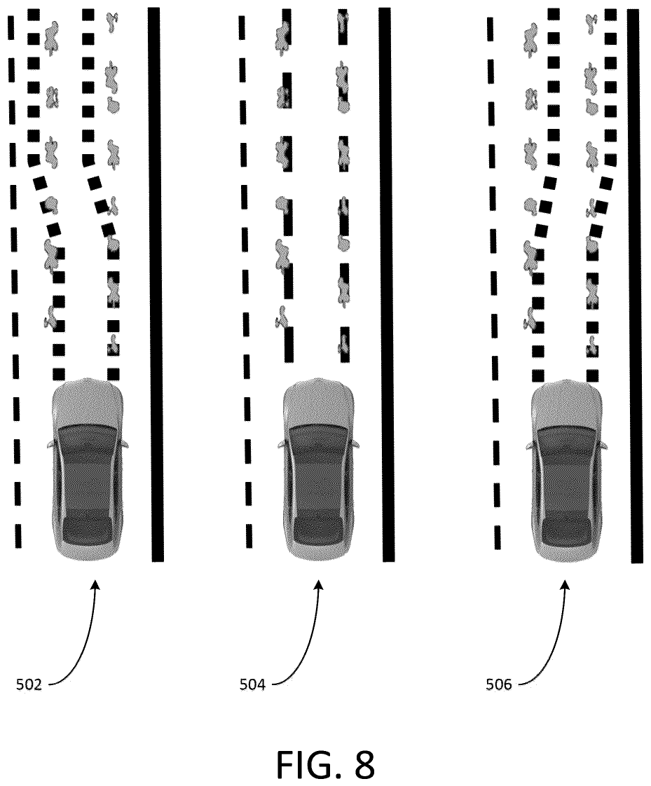

According to an exemplary embodiment, the vehicle/system may be configured to enable a drive and/or vehicle system to select a bias path (e.g., a left bias path 502, a center bias path 504, and/or a right bias path 506, as shown, e.g., in FIG. 8). According to an exemplary embodiment, when one bias path is rough, that bias path may not be selectable. For example, when a center bias path 504 is rough, only a left bias path 502 or a right bias path 506 may be available.

According to an exemplary embodiment, when a bias path is selectable, the bias path may be selected by the driver and/or the vehicle/system based on sensor input.

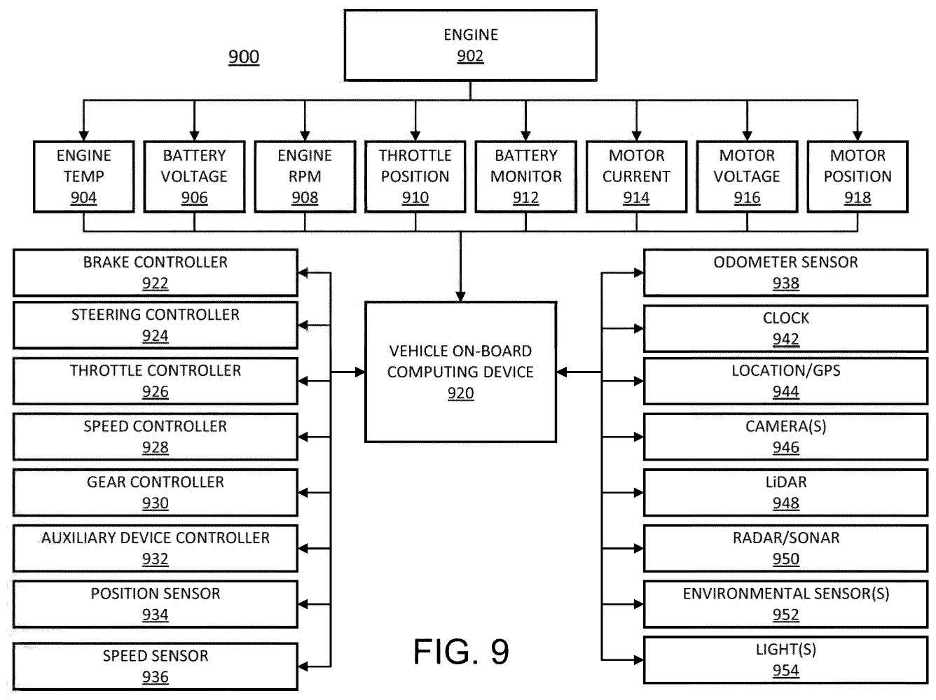

Referring now to FIG. 9, an example vehicle system architecture 900 for a vehicle is provided, in accordance with an exemplary embodiment of the present disclosure. The following discussion of vehicle system architecture 900 is sufficient for understanding one or more components of vehicle 100.

As shown in FIG. 9, the vehicle system architecture 900 may comprise an engine, motor or propulsive device 902 and various sensors 904-918 for measuring various parameters of the vehicle system architecture 900. In gas-powered or hybrid vehicles having a fuel-powered engine, the sensors 904-918 may comprise, for example, an engine temperature sensor 904, a battery voltage sensor 906, an engine Rotations Per Minute (RPM) sensor 908, and/or a throttle position sensor 910. If the vehicle is an electric or hybrid vehicle, then the vehicle may comprise an electric motor, and accordingly may comprise sensors such as a battery monitoring system 912 (to measure current, voltage and/or temperature of the battery), motor current 914 and voltage 916 sensors, and motor position sensors such as resolvers and encoders 918.

Operational parameter sensors that are common to both types of vehicles may comprise, for example: a position sensor 934 such as an accelerometer, gyroscope and/or inertial measurement unit; a speed sensor 936; and/or an odometer sensor 938. The vehicle system architecture 900 also may comprise a clock 942 that the system uses to determine vehicle time and/or date during operation. The clock 942 may be encoded into the vehicle on-board computing device 920, it may be a separate device, or multiple clocks may be available.

The vehicle system architecture 900 may comprise various sensors that operate to gather information about the environment in which the vehicle is traveling. These sensors may comprise, for example: a location sensor 944 (for example, a Global Positioning System (GPS) device); object detection sensors such as one or more cameras 946; a LiDAR sensor system 948; and/or a radar and/or a sonar system 950. The sensors may comprise environmental sensors 952 such as, e.g., a humidity sensor, a precipitation sensor, a light sensor, and/or ambient temperature sensor. The object detection sensors may be configured to enable the vehicle system architecture 900 to detect objects that are within a given distance range of the vehicle in any direction, while the environmental sensors 952 may be configured to collect data about environmental conditions within the vehicle's area of travel. According to an exemplary embodiment, the vehicle system architecture 900 may comprise one or more lights 954 (e.g., headlights, flood lights, flashlights, etc.).

During operations, information may be communicated from the sensors to an on-board computing device 920 (e.g., computing device 125, computing device 1000). The on-board computing device 920 may be configured to analyze the data captured by the sensors and/or data received from data providers and may be configured to optionally control operations of the vehicle system architecture 900 based on results of the analysis. For example, the on-board computing device 920 may be configured to control: braking via a brake controller 922; direction via a steering controller 924; speed and acceleration via a throttle controller 926 (in a gas-powered vehicle) or a motor speed controller 928 (such as, e.g., a variable frequency drive (VFD) controller, a current level controller in an electric vehicle, and/or other suitable motor speed controller); a differential gear controller 930 (in vehicles with transmissions); and/or other controllers. The brake controller 922 may comprise a pedal effort sensor, pedal position sensor, and/or simulator temperature sensor, as described herein.

Geographic location information may be communicated from the location sensor 944 to the on-board computing device 920, which may then access a map of the environment that corresponds to the location information to determine known fixed features of the environment such as streets, buildings, stop signs and/or stop/go signals. Captured images from the cameras 946 and/or object detection information captured from sensors such as LiDAR 948 may be communicated from those sensors to the on-board computing device 920. The object detection information and/or captured images may be processed by the on-board computing device 920 to detect objects in proximity to the vehicle. Any known or to be known technique for making an object detection based on sensor data and/or captured images may be used in the embodiments disclosed in this document.

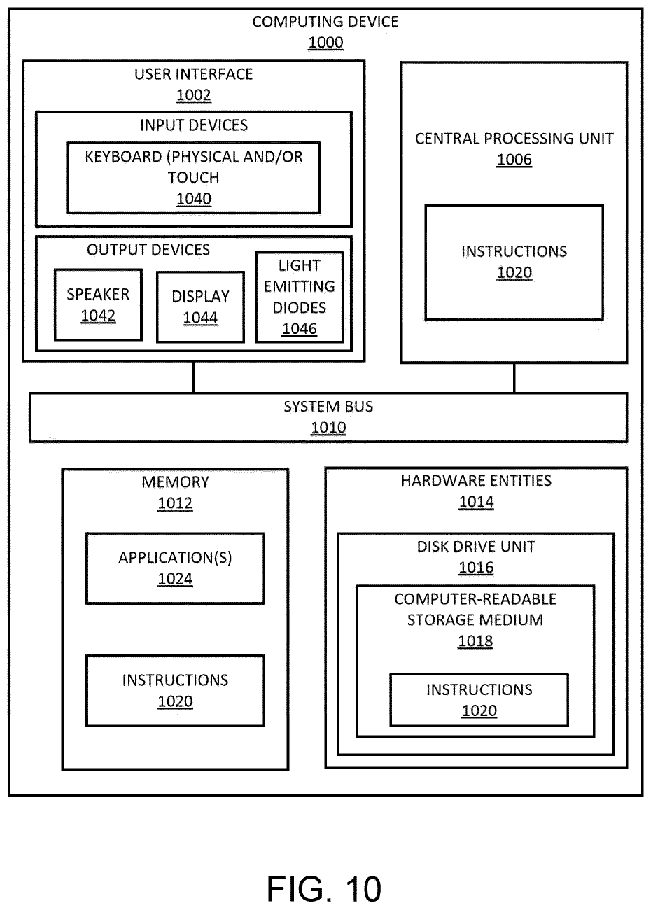

Referring now to FIG. 10, an illustration of an example architecture for a computing device 1000 is provided. According to an exemplary embodiment, one or more functions of the present disclosure may be implemented by a computing device such as, e.g., computing device 1000 or a computing device similar to computing device 1000. Computing device 1000 may be a quantum computer, a classical computer, and/or have one or more components configured to perform one or more quantum and/or classical computing functions. Computing device 125 and/or computing device 920 may be an example of computing device 1000 and/or may comprise one or more components of computing device 1000.

The hardware architecture of FIG. 10 represents one example implementation of a representative computing device configured to implement at least a portion of the systems/devices (e.g., vehicle 100) and method(s)/control logic(s) (e.g., method 200) described herein.

Some or all components of the computing device 1000 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors), The passive and/or active components may be adapted to, arranged to, and/or programmed to perform one or more of the methodologies, procedures, or functions described herein.

As shown in FIG. 10, the computing device 1000 may comprise a user interface 1002 (e.g. a graphical user interface), a Central Processing Unit (“CPU”) 1006, a system bus 1010, a memory 1012 connected to and accessible by other portions of computing device 1000 through system bus 1010, and hardware entities 1014 connected to system bus 1010. The user interface may comprise input devices and output devices, which may be configured to facilitate user-software interactions for controlling operations of the computing device 1000. The input devices may comprise, but are not limited to, a physical and/or touch keyboard 1040. The input devices may be connected to the computing device 1000 via a wired or wireless connection (e.g., a Bluetooth® connection). The output devices may comprise, but are not limited to, a speaker 1042, a display 1044, and/or light emitting diodes 1046.

At least some of the hardware entities 1014 may be configured to perform actions involving access to and use of memory 1012, which may be a Random Access Memory (RAM), a disk drive and/or a Compact Disc Read Only Memory (CD-ROM), among other suitable memory types. Hardware entities 1014 may comprise a disk drive unit 1016 comprising a computer-readable storage medium 1018 on which may be stored one or more sets of instructions 1020 (e.g., programming instructions such as, but not limited to, software code) configured to implement one or more of the methodologies, procedures, or functions described herein. The instructions 1020 may also reside, completely or at least partially, within the memory 1012 and/or within the CPU 1006 during execution thereof by the computing device 1000.

The memory 1012 and the CPU 1006 may also constitute machine-readable media. The term “machine-readable media”, as used here, refers to a single medium or multiple media (e.g., a centralized or distributed database, and/or associated caches and servers) that store the one or more sets of instructions 1020. The term “machine-readable media”, as used here, also refers to any medium that is capable of storing, encoding, or carrying a set of instructions 1020 for execution by the computing device 1000 and that cause the computing device 1000 to perform any one or more of the methodologies of the present disclosure. According to various embodiments, one or more computer applications 1024 may be stored on the memory 1012.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A system for detecting rough road surfaces and using lane-keep assist system (LKAS) biasing to avoid rough road surfaces, comprising:
a vehicle;
one or more sensors coupled to the vehicle and configured to image an environment of a vehicle; and
a computing device, comprising a processor and a memory, wherein the memory is configured to store instructions that, when executed by the processor, are configured to cause the processor to:
receive input from the one or more sensors;
determine one or more vehicle path areas on a road surface using the input from the one or more sensors,
wherein the one or more vehicle path areas comprise a current vehicle path area and one or more alternative vehicle path areas;
evaluate the one or more vehicle path areas for one or more rough road surfaces; and
bias an LKAS to avoid one or more rough road surfaces.

2. The system of claim 1, wherein the biasing the LKAS comprises changing a current LKAS bias offset to a new LKAS bias offset that follows an alternative vehicle path area, of the one or more vehicle path areas.

3. The system of claim 2, wherein the instructions, when executed by the processor, are further configured to verify that the new LKAS bias offset provides improved ride quality of the vehicle.

4. The system of claim 3, wherein the verifying that the new LKAS bias offset provides improved ride quality of the vehicle comprises comparing noise and vibration values for the new LKAS bias offset against noise and vibration values of a previous LKAS bias offset.

5. The system of claim 4, wherein the verifying that the new LKAS bias offset provides improved ride quality of the vehicle comprises, when the noise and vibration values for the new LKAS bias offset are not improved over the noise and vibration values of the previous LKAS bias offset, biasing the LKAS to revert back to the previous LKAS bias offset.

6. The system of claim 1, wherein the evaluating the one or more vehicle path areas for the one or more rough road surfaces comprises:
dividing each vehicle path area, of the one or more vehicle path areas, into a coordinate grid comprising a plurality of grid locations; and
evaluating each grid location, of the plurality of grid locations, for roughness.

7. The system of claim 6, wherein the biasing the LKAS to avoid the one or more rough road surfaces comprises determining whether roughness has been detected.

8. The system of claim 7, wherein the biasing the LKAS to avoid the one or more rough road surfaces comprises, when roughness has been detected:
grading the roughness; and
calculating a total path roughness score for each vehicle path area, of the one or more vehicle path areas.

9. The system of claim 8, wherein the biasing the LKAS to avoid the one or more rough road surfaces comprises:
determining whether a total path roughness score for an alternative vehicle path area is less than a total path roughness score for the current vehicle path area; and
when the total path roughness score for the alternative vehicle path area is less than the total path roughness score for the current vehicle path area, changing an LKAS bias offset to following the alternative vehicle path area.

10. The system of claim 1, wherein the one or more sensors comprise one or more of the following: one or more cameras; one or more LiDAR sensors; one or more radar sensors; one or more noise sensors; and one or more vibration sensors.

11. A method for detecting rough road surfaces and using lane-keep assist system (LKAS) biasing to avoid rough road surfaces, comprising:
imaging an environment of a vehicle, using one or more sensors coupled to the vehicle;
receiving input from the one or more sensors, using a computing device,
wherein the computing device comprises a processor and a memory; and
using the computing device:
determining one or more vehicle path areas on a road surface using the input from the one or more sensors,
wherein the one or more vehicle path areas comprise a current vehicle path area and one or more alternative vehicle path areas;
evaluating the one or more vehicle path areas for one or more rough road surfaces; and
biasing an LKAS to avoid one or more rough road surfaces.

12. The method of claim 11, wherein the biasing the LKAS comprises changing a current LKAS bias offset to a new LKAS bias offset that follows an alternative vehicle path area, of the one or more vehicle path areas.

13. The method of claim 12, further comprising verifying that the new LKAS bias offset provides improved ride quality of the vehicle.

14. The method of claim 13, wherein the verifying that the new LKAS bias offset provides improved ride quality of the vehicle comprises comparing noise and vibration values for the new LKAS bias offset against noise and vibration values of a previous LKAS bias offset.

15. The method of claim 14, wherein the verifying that the new LKAS bias offset provides improved ride quality of the vehicle comprises, when the noise and vibration values for the new LKAS bias offset are not improved over the noise and vibration values of the previous LKAS bias offset, biasing the LKAS to revert back to the previous LKAS bias offset.

16. The method of claim 11, wherein the evaluating the one or more vehicle path areas for the one or more rough road surfaces comprises:
dividing each vehicle path area, of the one or more vehicle path areas, into a coordinate grid comprising a plurality of grid locations; and
evaluating each grid location, of the plurality of grid locations, for roughness.

17. The method of claim 16, wherein the biasing the LKAS to avoid the one or more rough road surfaces comprises determining whether roughness has been detected.

18. The method of claim 17, wherein the biasing the LKAS to avoid the one or more rough road surfaces comprises, when roughness has been detected:
grading the roughness; and
calculating a total path roughness score for each vehicle path area, of the one or more vehicle path areas.

19. The method of claim 18, wherein the biasing the LKAS to avoid the one or more rough road surfaces comprises:
determining whether a total path roughness score for an alternative vehicle path area is less than a total path roughness score for the current vehicle path area; and
when the total path roughness score for the alternative vehicle path area is less than the total path roughness score for the current vehicle path area, changing an LKAS bias offset to following the alternative vehicle path area.

20. The method of claim 11, wherein the one or more sensors comprise one or more of the following: one or more cameras; one or more LiDAR sensors; one or more radar sensors; one or more noise sensors; and one or more vibration sensors.
